(19) United States
(12) Patent Application Publication
(10) Pub. No.: US 2016/0160748 A1
(43) Pub. Date: Jun. 9, 2016

(54) BYPASS VALVE DEVICE OF MULTISTAGE TURBOCHARGER

(71) Applicant: Hyundai Motor Company, Seoul (KR)

(72) Inventor: Seok Beom Jin, Seongnam-si (KR)

(73) Assignee: Hyundai Motor Company, Seoul (KR)

(21) Appl. No.: 14/805,217

(22) Filed: Jul. 21, 2015

(30) Foreign Application Priority Data
Dec. 4, 2014 (KR) 10-2014-0172814

(51) Int. Cl. F02B 37/18; F16K 1/20

(52) U.S. Cl. CPC F02B 37/183; F16K 1/20

(57) ABSTRACT

A bypass valve device of a multistage turbocharger may include a guide arm adjacently disposed at an inlet of a bypass passage and having a first end rotatably mounted through a rotating shaft, and an opening and closing valve freely rotatably coupled to a second end of the guide arm, having a valve surface which covers a cross section of the inlet, and configured to rotate at the guide arm at a time of contacting the inlet so that the valve surface face-contacts the cross section of the inlet.

### CROSS REFERENCE TO RELATED APPLICATION

The present application claims priority to Korean Patent Application No. 10-2014-0172814, filed Dec. 4, 2014, the entire contents of which is incorporated herein for all purposes by this reference.

### BACKGROUND OF THE INVENTION

1. Field of the Invention

The present invention relates to a bypass valve device of a multistage turbocharger, and more particularly, to a bypass valve device of a multistage turbocharger to enable a bypass valve to completely close a bypass passage at the time of closing the bypass passage.

2. Description of Related Art

A high pressure turbo device which is connected to an exhaust manifold and a low pressure turbo device which is connected to the high pressure turbo device are provided, a high pressure turbine is provided with a waste gate valve, and pressurized air from a high pressure compressor is cooled by an intercooler and then is supplied to an intake manifold of an engine.

The existing two-stage turbo system configured as described above uses flow energy of exhaust gas discharged from the exhaust manifold of the engine to rotate the high pressure turbine and the low pressure turbine and allows the low pressure compressor to primarily pressurize air and then a high pressure compressor to secondarily pressurize the air, and supplies the pressurized air to the engine through the intercooler.

When the engine enters a high-speed and high-load operation state, allowable flow capacity of the high pressure turbine device is smaller than a flow rate discharged from the exhaust manifold, and therefore the waste gate valve is opened to bypass the exhaust gas.

The waste gate valve contacts a seating face of the bypass passage at the time of fully closing the bypass passage. In this case, exhaust gas is leaked from the waste gate valve and the seating face of the bypass passage due to the occurrence of assembly tolerance and dimension tolerance considering thermal deformation when the seating face is abnormally machined or thermally deformed, such that the turbo performance may be reduced.

In particular, as illustrated in FIG. 1, a waste gate valve 1 may relatively rotate with respect to a rotating shaft 3 and thus when the waste gate valve 1 contacts a seating face 7 of the bypass passage 5, the waste gate valve 1 does not adhere to the seating face of the bypass passage 5. Consequently, a problem of the occurrence of leak may be never solved.

Therefore, a need exists for a method for enabling a waste gate valve to completely close a bypass passage when the bypass passage is abnormally machined or thermally deformed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a bypass valve device of a multistage turbocharger to close a bypass passage by making the bypass valve completely adhere to a seating face of the bypass passage when the bypass valve fully closes the bypass passage.

According to various aspects of the present invention, a bypass valve device of a multistage turbocharger may include a guide arm adjacently disposed at an inlet of a bypass passage and having a first end rotatably mounted through a rotating shaft, and an opening and closing valve freely rotatably coupled to a second end of the guide arm, having a valve surface which covers a cross section of the inlet, and configured to rotate at the guide arm at a time of contacting the inlet so that the valve surface face-contacts the cross section of the inlet.

The guide arm may have the first end connected to the rotating shaft and the second end provided with a vertically penetrating mounting hole, and the opening and closing valve may be connected to the guide arm by inserting a middle portion of the opening and closing valve into the mounting hole of the guide arm and outer circumferential diameters of an upper portion and a lower portion of the opening and closing valve are larger than an inner circumferential diameter of the mounting hole.

The inner circumferential diameter of the mounting hole may be formed to be larger than an outer circumferential diameter of the middle portion of the opening and closing valve to form a gap between the mounting hole and the middle portion of the opening and closing valve.

An inner circumference of the mounting hole may be provided with an inclined surface having an inner circumferential diameter that is gradually widened toward the valve surface and the middle portion of the opening and closing valve may be provided with a contact protrusion which corresponds to the inclined surface.

The inclined surface of the mounting hole may be formed to be bent toward the valve surface and the contact protrusion of the opening and closing valve may be formed to be bent corresponding to the inclined surface.

The upper portion of the opening and closing valve may be provided with a locking protrusion which protrudes to be larger than the inner circumferential diameter of the mounting hole, and the second end of the guide arm may be provided with a locking groove which has an upper end dented to enclose the locking protrusion and an inner circumferential diameter of the locking groove may be formed to be larger than an outer circumferential diameter of the locking protrusion.

The lower portion of the opening and closing valve may be formed to be wider than the cross section of the inlet, thus even though the opening and closing valve rotates at the guide arm at the time of contacting the inlet, the valve surface covers the cross section of the inlet.

The inclined surface of the mounting hole and the contact protrusion of the opening and closing valve may have partial spherical shapes to fit each other, respectively.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a two-stage turbocharger according to the related art.

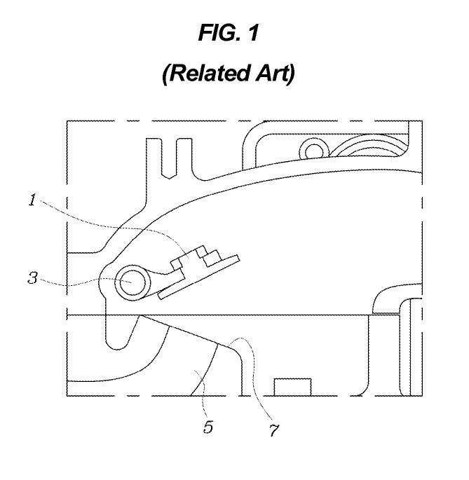

FIG. 2 is a diagram illustrating an exemplary bypass valve device of a multistage turbocharger according to the present invention.

FIG. 3 is a diagram for describing the exemplary bypass valve device of a multistage turbocharger illustrated in FIG. 2.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below.

While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

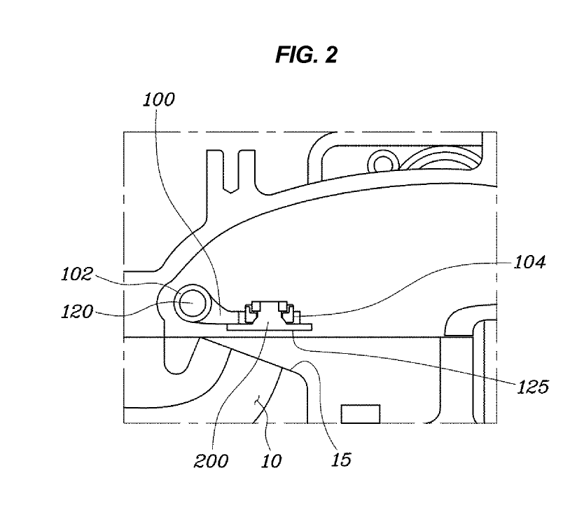

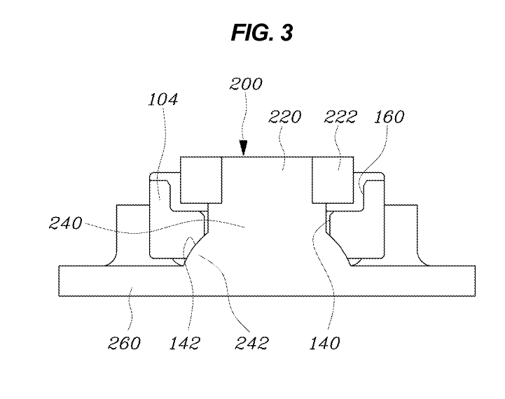

FIG. 2 is a diagram illustrating a bypass valve device of a multistage turbocharger according to various embodiments of the present invention and FIG. 3 is a diagram for describing the bypass valve device of a multistage turbocharger illustrated in FIG. 2.

According to the two-stage turbocharger of the present invention in which at least two turbo devices are included, a bypass valve (waste gate valve) used when exhaust gas is bypassed from a high pressure turbo device to a low pressure turbo device adheres to an inlet 15 of a bypass passage 10 at the time of contacting therebetween to prevent gas from being leaked.

Further, the bypass valve device according to the exemplary embodiment of the present invention may also be applied to a bypass of a general turbocharger to prevent gas from being leaked.

As illustrated in FIG. 2, the bypass valve device of a multistage turbocharger according to various embodiments of the present invention includes a guide arm 100 configured to be adjacently disposed to the inlet 15 of the bypass passage 10 and have one end 102 rotatably mounted through a rotating shaft 120, and an opening and closing valve 200 configured to be freely rotatably coupled with the other end 104 of the guide arm 100, have a valve surface 125 which covers a cross section of the inlet 15, and rotate at the guide arm 100 at the time of contacting the inlet 15 so that the valve surface 125 face-contacts the cross section of the inlet 15.

That is, according to various embodiments of the present invention, the guide arm 100 is adjacently mounted to the inlet 15 of the bypass passage 10 through the rotating shaft 120 and the opening and closing valve 200 which is connected to the guide arm 100 rotates along with the guide arm 100 to close the inlet 15 of the bypass passage 10.

In particular, according to various embodiments of the present invention, the other end 104 of the guide arm 100 is freely rotatably coupled with the opening and closing valve 200 and thus the opening and closing valve 200 rotates when the opening and closing valve 200 contacts the inlet 15 of the bypass passage 10 so that the valve surface 125 of the opening and closing valve 200 face-contacts the cross section of the inlet 15. That is, the opening and closing valve 200 is configured to freely rotate at the guide arm 100, such that when the inlet 15 of the bypass passage 10 is abnormally machined or thermally deformed and thus a cross section thereof is inclined, as the opening and closing valve 200 rotates to meet the inclination, the valve surface 125 of the opening and closing valve 200 face-contacts the inlet 15 of the bypass passage 10 while following up a cross section thereof.

As the result, when the bypass valve closes the bypass passage 10, the bypass valve completely adheres to the cross section of the inlet 15 of the bypass passage 10 to prevent gas from being leaked from the bypass passage 10.

Describing in detail various embodiments of the present invention, as illustrated in FIG. 3, the guide arm 100 has one end 102 connected to the rotating shaft 120 and the other end 104 provided with a vertically penetrating mounting hole 140, the opening and closing valve 200 is connected to the guide arm 100 by inserting a middle portion 240 into the mounting hole 140 of the guide arm 100, and outer circumferential diameters of an upper portion 220 and a lower portion 260 thereof may be formed to be larger than an inner circumferential diameter of the mounting hole 140.

That is, the guide arm 100 has one end 102 connected to the rotating shaft 120 and a rotating angle thereof may be controlled depending on a control of a controller. In this case, a value of the rotating angle may be set based on a driving speed of a vehicle, a load of an engine.

The other end 104 of the guide arm 100 is provided with a vertically penetrating mounting hole 140 and a middle portion of the opening and closing valve 200 is inserted into the mounting hole 140 and thus the opening and closing valve 200 rotates along with the guide arm 100. Here, the outer circumferential diameters of the upper portion 220 and the lower portion 260 of the opening and closing valve 200 are formed to be larger than the inner circumferential diameter of the mounting hole 140, and thus the upper portion 220 and the lower portion 260 of the opening and closing valve 200 are locked to an upper end and a lower end of the other end 104 of the guide arm 100 to be prevented from separating.

In detail, the inner circumferential diameter of the mounting hole 140 is formed to be larger than the outer circumferential diameter of the middle portion 240 of the opening and closing valve 200 to form a gap between the mounting hole 140 and the middle portion 240 of the opening and closing valve 200.

As such, the inner circumferential diameter of the mounting hole 140 is formed to be larger than the outer circumferential diameter of the middle portion 240 of the opening and closing valve 200 and thus the gap is formed, such that a space in which the opening and closing valve 200 may freely rotate in the mounting hole 140 is secured.

Along with this, an inner circumference of the mounting hole 140 may be provided with an inclined surface 142 of which the inner circumferential diameter is gradually widened toward the valve surface 125 and the middle portion 240 of the opening and closing valve 200 may be provided with a contact protrusion 242 which corresponds to the inclined surface 142. More preferably, the inclined surface 142 of the mounting hole 140 is formed to be bent toward the valve surface 125 and the contact protrusion 242 of the opening and closing valve 200 may be formed to be bent corresponding to the inclined surface 142.

That is, as illustrated in FIG. 3, the inner circumference of the mounting hole 140 is provided with an inclined surface 142 of which the inner circumferential diameter is gradually widened toward the valve surface 125 and the middle portion 240 of the opening and closing valve 200 is provided with the contact protrusion 242 corresponding to the inclined surface 142, such that when the opening and closing valve 200 rotates in the mounting hole 140 of the guide arm 100, the opening and closing valve 200 stably rotates in a state in which the contact protrusion 242 of the opening and closing valve 200 contacts the inclined surface 142 of the mounting hole 140.

Further, when the opening and closing valve 200 rotates, the contact protrusion 242 contacts the inclined surface 142 of the mounting hole 140 to limit an excessive rotation of the opening and closing valve 200, and thus as the guide arm 100 rotates, the opening and closing valve 200 may stably contact the inlet 15 of the bypass passage 10.

Along with this, the inclined surface 142 of the mounting hole 140 and the contact protrusion 242 of the opening and closing valve 200 are formed in a bent shape corresponding to each other to spherical-contact each other, such that when the opening and closing valve 200 rotates, the opening and closing valve 200 may softly and smoothly rotate in the state in which the contact protrusion 242 contacts the inclined surface 142.

Here, the shapes of the inclined surface 142 of the mounting hole 140 and the contact protrusion 242 corresponding thereto are formed to be bent toward the valve surface 125, and thus may be formed in a convex shape or a concave shape, as illustrated in FIG. 3.

Meanwhile, the upper portion 220 of the opening and closing valve 200 is provided with a locking protrusion 222 which protrudes to be larger than the inner circumferential diameter of the mounting hole 140, the other end 104 of the guide arm 100 is provided with a locking groove 160 which has an upper end dented to enclose the locking protrusion 222, and the inner circumferential diameter of the locking groove 160 may be formed to be larger than the outer circumferential diameter of the locking protrusion 222.

Further, the lower portion 260 of the opening and closing valve 200 is formed to be wider than the cross section of the inlet 15 and thus even though the opening and closing valve 200 rotates at the guide arm 100 at the time of contacting the inlet 15, the valve surface 125 covers the cross section of the inlet 15.

That is, the locking protrusion 222 which is formed at the upper portion 220 of the opening and closing valve 200 is inserted into the locking groove 160 which is formed at the other end 104 of the guide arm 100 and as the lower portion 260 of the opening and closing valve 200 is formed to be wider than the cross section of the inlet 15, the lower portion of the opening and closing valve 200 is formed to be larger than the other end 104 of the guide arm, and thus the opening and closing valve 200 is prevented from separating vertically from the guide arm 100.

Further, the inner circumferential diameter of the locking groove 160 of the guide arm 100 is formed to be larger than the outer circumferential diameter of the locking protrusion 222, and thus a gap is formed between the locking protrusion 222 and the locking groove 160, thereby smoothing the rotation of the opening and closing valve 200. The locking protrusion 222 is configured to be separately coupled with the upper portion 220 of the opening and closing valve 220, and thus the opening and closing valve 200 may be easily assembled with the other end 104 of the guide arm 100.

The lower portion 260 of the opening and closing valve 200 is formed to be wider than the cross section of the inlet 15, and thus when the opening and closing valve 200 contacts the inlet 15 while being locked to the other end 104 of the guide arm 100, completely covers the inlet 15 of the bypass passage 10 to prevent gas from being leaked.

According to the bypass valve device of a multistage turbocharger configured as described above, it is possible to close the bypass passage 10 by making the bypass valve 10 completely adhere to the left face of the bypass passage when the bypass valve closes the bypass passage 10.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A bypass valve device of a multistage turbocharger, comprising:
a guide arm adjacently disposed at an inlet of a bypass passage and having a first end rotatably mounted through a rotating shaft; and
an opening and closing valve freely rotatably coupled to a second end of the guide arm, having a valve surface which covers a cross section of the inlet, and configured to rotate at the guide arm at a time of contacting the inlet so that the valve surface face-contacts the cross section of the inlet.

2. The bypass valve device of claim 1, wherein the guide arm has the first end connected to the rotating shaft and the second end provided with an mounting hole, and
the opening and closing valve is connected to the guide arm by inserting a middle portion of the opening and closing valve into the mounting hole of the guide arm and outer circumferential diameters of an upper portion and a lower portion of the opening and closing valve are larger than an inner circumferential diameter of the mounting hole.

3. The bypass valve device of claim 2, wherein the inner circumferential diameter of the mounting hole is formed to be larger than an outer circumferential diameter of the middle portion of the opening and closing valve to form a gap between the mounting hole and the middle portion of the opening and closing valve.

4. The bypass valve device of claim 2, wherein an inner circumference of the mounting hole is provided with an inclined surface having an inner circumferential diameter that is gradually widened toward the valve surface and the middle portion of the opening and closing valve is provided with a contact protrusion which corresponds to the inclined surface.

5. The bypass valve device of claim 4, wherein the inclined surface of the mounting hole is formed to be bent toward the valve surface and the contact protrusion of the opening and closing valve is formed to be bent corresponding to the inclined surface.

6. The bypass valve device of claim 2, wherein the upper portion of the opening and closing valve is provided with a locking protrusion which protrudes to be larger than the inner circumferential diameter of the mounting hole, and
the second end of the guide arm is provided with a locking groove which has an upper end dented to enclose the locking protrusion and an inner circumferential diameter of the locking groove is formed to be larger than an outer circumferential diameter of the locking protrusion.

7. The bypass valve device of claim 2, wherein the lower portion of the opening and closing valve is formed to be wider than the cross section of the inlet, thus even though the opening and closing valve rotates at the guide arm at the time of contacting the inlet, the valve surface covers the cross section of the inlet.

8. The bypass valve device of claim 5, wherein the inclined surface of the mounting hole and the contact protrusion of the opening and closing valve have partial spherical shapes to fit each other, respectively.
